(19) United States
(12) Patent Application Publication
(10) Pub. No.: US 2017/0276294 A1
(43) Pub. Date: Sep. 28, 2017

(54) BOSS AND LINER INTERFACE FOR A PRESSURE VESSEL

(71) Applicant: WORTHINGTON INDUSTRIES, INC., Columbus, OH (US)

(72) Inventors: RUSSELL ALMAGRO, POMONA, CA (US); KENNETH O. MILLER, POMONA, CA (US)

(21) Appl. No.: 15/464,744

(22) Filed: Mar. 21, 2017

Related U.S. Application Data
(60) Provisional application No. 62/311,970, filed on Mar. 23, 2016.

(51) Int. Cl. F17C 1/06; B29C 45/14; F17C 13/00; B29C 65/48; F17C 1/14; F17C 1/16

(52) U.S. Cl. CPC F17C 1/06; F17C 1/14; F17C 1/16; F17C 13/002; B29C 65/48; B29C 45/14; F17C 2260/036; F17C 2203/0604; F17C 2203/066; F17C 2203/0663; F17C 2205/0305; F17C 2209/2118; B29L 2031/7156

(57) ABSTRACT

A pressure vessel includes a liner, a composite shell covering the liner, and at least one boss assembly having a metal boss. The metal boss is positioned at respective openings though the liner and the composite shell. A plastic layer is formed between the liner and the metal boss. The plastic layer adheres to both the metal boss and the liner to form a seal at the interface between the metal boss and liner. The plastic layer further increases a torque strength of the metal boss.

### CROSS-REFERENCE TO RELATED APPLICATIONS

This U.S. patent application claims priority to and the benefit of U.S. Provisional Patent Application Ser. No. 62/311,970 filed on Mar. 23, 2016. The entirety of the aforementioned application is herein incorporated by reference.

### TECHNICAL FIELD

In general, the present invention relates to pressure vessels, and in particular, to an interface between a boss and a liner of a pressure vessel.

### BACKGROUND OF THE INVENTION

Pressure vessels commonly contain various fluids under pressure such as, for example, natural gas, oxygen, nitrogen, propane, fuels, and the like. Design considerations for such pressure vessels can vary depending on type of fluid stored and desired application. Standardized types of pressure vessels, referred to as Types I to V, exist for containing fluids such as compressed natural gas (CNG), hydrogen, and the like.

Type I pressure vessels include vessels having an all-metal construction, which is commonly steel. Type II pressure vessels include metal vessels with reinforcement. Specifically, such vessels include a fiber-reinforced composite wound about the vessel in a hoop direction such that the vessel and wound composite share substantially equal structural loading. Typically, the metal vessel is steel or aluminum, and the fiber-reinforced composite includes a polymer having glass, carbon, basalt, or aramid fibers. Type III pressure vessels include a metal liner with a carbon fiber composite overwrap such that the composite carries a majority of structural loading. The metal liner is typically aluminum. Type IV pressure vessels have a metal-free construction with, typically, a carbon fiber or hybrid carbon/glass fiber composite wound over a thermoplastic polymer liner such that the composite material carries substantially all of the structural loading. For instance, the liner is often high-density polyethylene (HDPE) or polyamide. Type V pressure vessels have an all-composite construction, without a liner, such that the composite material carries loads and contains the fluid.

In general, an inverse relationship exists between cost and weight such that decreasing the weight of a pressure vessel leads to an increase in cost. Type I pressure vessels typically are the least expensive but heaviest. Conversely, Type V pressure vessels are the lightest but also the most expensive. For vehicle fuel tanks, Type III and IV pressure vessels are commonly utilized. The composite materials reduces fuel system and, therefore, vehicle weight, which leads to improved fuel economy and load-carrying capacity. Moreover, composite materials provide pressure vessels offering higher energy storage density by accommodating greater containment pressures. Further, composite materials extend lifetimes of pressure vessels through improved corrosion and fatigue resistance

Type IV pressure vessels, while advantageous compared to Type III pressure vessels in some applications, can suffer performance issues under certain conditions. For example, the thermoplastic polymer liner of a pressure vessel cannot generally accept a threadable valve directly. Rather, a threaded metal boss, attached to the liner, provides support for the valve. Leaks can develop at the metal-liner interface with increased operating pressures and/or with fluids with relatively small molecular sizes. The leaks result in fluid loss, which causes economic losses or potentially hazardous conditions.

### SUMMARY OF THE INVENTION

A simplified summary is provided herein to help enable a basic or general understanding of various aspects of exemplary, non-limiting embodiments that follow in the more detailed descriptions and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, a pressure vessel is provided that includes a liner, a composite shell covering the liner, and at least one boss assembly. The boss assembly includes a metal boss having a main portion and a flange extending from the main portion. The flange extends between the liner and the composite shell. A plastic layer is formed between the flange and the liner. The plastic layer includes a material which adheres both to metal and a material forming the liner. The plastic layer provides a high-pressure seal along the interface between the metal boss and the liner. The plastic layer also increases a torque strength of the metal boss such that slippage between the boss and the liner is reduced during attachment or engagement of valves, vents, caps, or the like to the boss.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a partial cross-section, elevational side view of an exemplary, non-limiting pressure vessel according to one or more aspects;

FIG. 2 illustrates an enlarged partial view of a forward portion of an exemplary, non-limiting pressure vessel in accordance with various aspects;

FIG. 3 illustrates a cross-section of an exemplary, non-limiting pressure vessel at the boss-liner interface according to one or more aspects;

FIG. 4 is a flow diagram for an exemplary, non-limiting embodiment for making a pressure vessel in accordance with one or more aspects;

FIG. 5 illustrates an exemplary, non-limiting embodiment of a boss according to various aspects;

FIG. 6 illustrates a cross-section of an exemplary, non-limiting pressure vessel at the boss-liner interface according to one or more aspects; and

FIG. 7 illustrates a cross-section of an exemplary, non-limiting pressure vessel at the boss-liner interface according to one or more aspects.

### DETAILED DESCRIPTION OF THE INVENTION

In various, non-limiting embodiments, a pressure vessel and associated methods of manufacture are provided. A pressure vessel, according to an example, includes a liner for containing a fluid and a composite shell covering the liner to bear structural loading. The liner can be high-density polyethylene or other suitable plastic or polymeric material. The shell can include a carbon-fiber wrap or other composite material. The liner and shell include respective openings into which a boss assembly is positioned to provide a channel for a of flow from an interior space, when desired, and to facilitate attachment of the pressure vessel to other systems depending on an application.

The boss assembly includes a metal boss, formed from aluminum or other metal, and having a main portion with a flange extending radially outward from the main portion. The flange extends between the liner and the composite shell. Prior to molding of the liner, the metal boss is primed with a plastic layer. In particular, according to one example, a convex surface of the flange is primed. The convex surface of the flange engages a surface of the liner. Accordingly, the plastic layer is disposed between the metal boss and the liner. The plastic layer is a different material than the liner and provides excellent adhesion to both metal and the liner. Thus, a high-pressure seal is formed at the interface between the metal boss and the liner. Moreover, the plastic layer reduces slippage between the metal boss and the liner when a torque is applied to the metal boss (i.e. when an object is threaded into or otherwise attached to the metal boss).

In one embodiment, a pressure vessel is described. The pressure vessel includes a liner forming a hollow interior space and a composite shell covering the liner. The pressure vessel further includes a metal boss positioned within respective openings through the liner and the composite shell. The metal boss includes a flange extending between the liner and the composite shell. In addition, a plastic layer is disposed between the liner and the metal boss to form a seal at the interface between the metal boss and the liner.

According to an example, the flange of the metal boss includes a convex inner surface on which the plastic layer adheres to secure the liner to the metal boss and form the seal at the interface. The pressure vessel can further include an O-ring configured to form a second seal between the liner and metal boss. In addition, the metal boss can include a central passage configured to receive and secure an insert at least partially within the central passage. The insert includes a central port providing a channel between the central passage of the metal boss and the hollow interior space formed by the liner. According to this example, the insert carries an O-ring to form a second seal where a lip of the liner extends between the insert and the metal boss. Upon insertion, the insert compresses a lip of the liner against the metal boss to form a second seal.

The metal boss can be aluminum or other metal and the liner can be high-density polyethylene, for example. The plastic layer includes a material providing adhesion to both the metal boss and a material of the liner. For instance, the plastic layer can be a modified thermoplastic polyethylene-based resin.

According to another embodiment, a pressure vessel is described having an HDPE liner forming a hollow interior space configured to contain a fluid and a carbon-fiber composite wrap covering the HDPE liner to form a shell. The vessel further includes a boss assembly positioned within respective openings through the HDPE liner and the composite wrap. The boss assembly includes a metal boss having a central passage and a flange extending radially outward from a main portion of the metal boss and between the HDPE liner and the composite wrap, and an insert configured to be at least partially received within the central passage. In addition, a plastic layer is formed between the flange of the metal boss and the HDPE liner to secure the metal boss to the HDPE liner and to form a seal along an interface between the metal boss and the HDPE liner.

According to an example, the central passage of the metal boss includes internal threads and the insert includes external threads such that the external threads of the insert cooperate with the internal threads of the metal boss to secure the insert when the insert is torqued during insertion. An O-ring can be externally positioned on the insert to form a second seal between the HDPE liner and the metal boss when the insert is at least partially received within the central passage of the metal boss.

In another example, the HDPE liner includes a lip that at least partially extends into the central passage of the metal boss. The insert includes a tapered inner portion configured to compress the lip of the HDPE liner against an engagement surface of the metal boss during insertion. The engagement surface includes a partially recessed groove to receive the HDPE liner compressed by the insert. Moreover, the plastic layer is disposed on and between the engagement surface of the metal boss and the HDPE liner.

In yet another embodiment, a method of manufacturing a pressure vessel is described. The method includes priming at least one surface of a metal boss with a plastic layer. In addition, the method includes molding a liner forming a hollow interior space with the metal boss integrated therewith. The metal boss can include a flange extending radially-outward which is at least partially integrated with the liner during molding. The method can further include forming a composite wrap that covers the liner and at least the flange of the metal boss.

In an example, the liner is rotationally molded and the plastic layer is formed on an inner surface of the flange so as to be between the metal boss and the liner when molded. Alternatively, the method can include injection molding the liner as at least two separate portions, coupling an insert to the metal boss from an inner side of the metal boss, and joining the at least two separate portions of the liner together after coupling.

With reference to the drawings, like reference numerals designate identical or corresponding parts throughout the several views. The inclusion of like elements in different views does not mean a given embodiment necessarily includes such elements or that all embodiments of the invention include such elements. The examples and figures are illustrative only and not meant to limit the invention, which is measured by the scope and spirit of the claims. Moreover, it should be understood that the drawings may not depict features to scale. Specific design features of pressure vessels, similar to those disclosed herein, such as, for example, specific dimensions, orientations, locations, and/or shapes are generally determined, in part, by a particular application and/or use environment. The drawings may enlarge or exaggerate certain features to facilitate visualization. For instance, thicknesses may be distorted to enhance understanding and visibility. All references to direction and position, unless otherwise indicated, refer to the orientation of the isolators illustrated in the drawings.

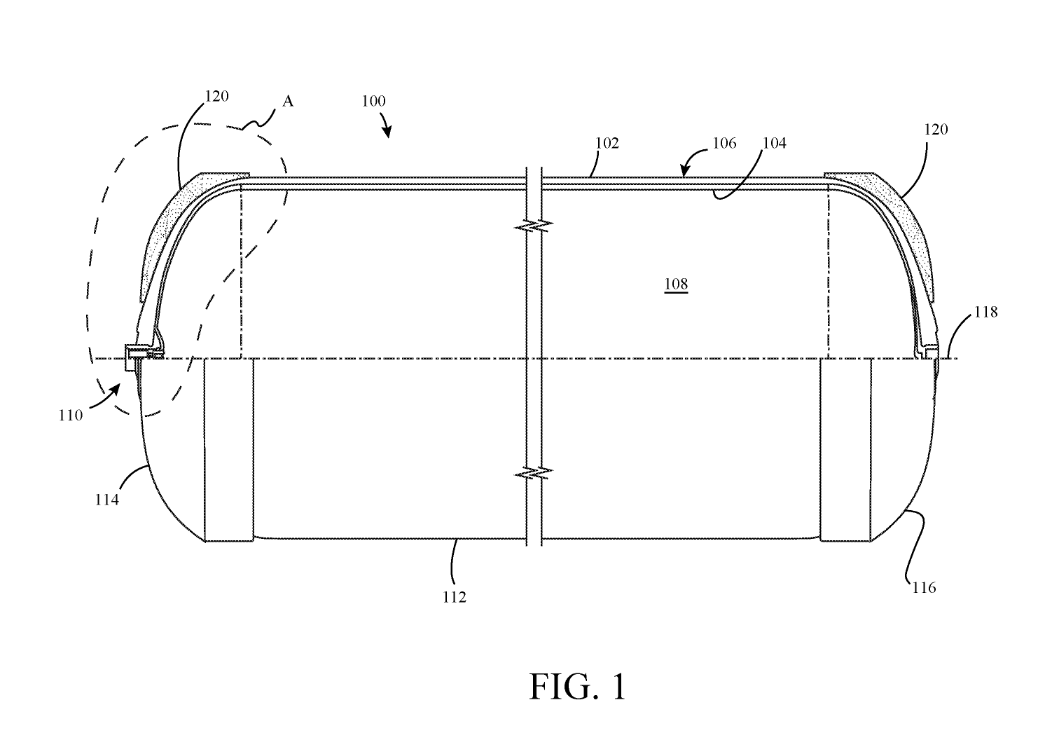

FIG. 1 illustrates an exemplary, non-limiting embodiment of a pressure vessel 100. In the example depicted in FIG. 1, pressure vessel 100 is a type IV vessel. As shown, pressure vessel 100 includes a tank 102 having a liner 104 and an outer shell 106 covering the liner 104. Liner 104 forms a hollow interior cavity 108 for containing a fluid. Tank 102 includes at least one opening in both liner 104 and shell 106 that receives a boss assembly 110 positioned therein. As a type IV vessel, tank 102 is substantially metal-free. Liner 104 forms and seals the interior space 108 The shell 106 covers liner 104 except where boss assembly 110 is provided. The shell 106 generally handles any structural loading.

As depicted, tank 102 includes a cylindrically-shaped main portion 112, a first end portion 114, and a second end portion 116. The first and second end portions 114, 116 are generally dome-shaped and respectively positioned at longitudinally opposed ends of main portion 112 relative to a central longitudinal axis 118. Dome caps 120 can be coupled to the first and second end portions 114, 116 for protection. The dome caps 120 can include an opening for the boss assembly 110. In an example, the dome caps 120 can attach to the wrap 106 with an adhesive. It is to be appreciated that alternative techniques, other than adhesives, can be utilized to secure the dome caps to the end portions 114, 116 of tank 102. In one aspect, the dome caps 120 can be a foam material or other suitable material and adapted to substantially any shape suitable to protect end portions of tank 102. The dome caps 120 can optionally be removed. The above description of tank 102 is exemplary and it is to be appreciated that pressure vessel 100 can have other shapes, orientations, dimensions, etc., based on a desired application.

According to an example, liner 104 includes high density polyethylene (HDPE). Other suitable polymers, such as polyamide or the like, can also be utilized. Shell 106 includes a composite material covering liner 104. As utilized herein, the term “composite” refers to a fiber-reinforced resin matrix material, which can be utilized in a filament winding or lamination process to form structures. In an embodiment, shell 106 can include a carbon fiber composite wrapped around liner 104 through filament winding. Alternatively, shell 106 can include a hybrid carbon/glass fiber composite, an aramid fiber composite, a hybrid aramid/glass fiber composite, or other suitable composite material, which is filament wound to wrap liner 104.

Pressure vessel 100, as shown in FIG. 1, can include two metal boss assemblies 110 located at the first end portion 114 and the second end portion 116, respectively. The metal boss assemblies 110 can be coaxially arranged along the longitudinal axis of the tank 112. Further, the metal boss assemblies 110 are position within respective aligned openings in liner 104 and shell 108. These boss assembly placements are merely illustrative and other locations on tank 112 and/or quantities of boss assemblies can be employed. For example, pressure vessel 100 can include a single boss assembly 110 disposed within the first end portion 114 or the second end portion 116, depending on application.

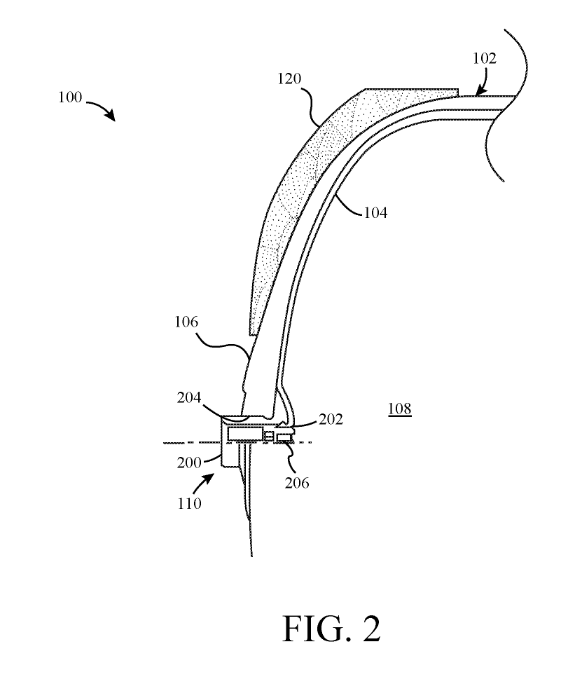

FIG. 2 illustrates an enlarged, partial view of region A of FIG. 1 showing the metal boss assembly 110. The boss assembly 110 includes a boss 200 located within aligned openings 202, 204 in liner 104 and shell 106, respectively. Without boss assembly 110 installed, openings 202, 204 provides a passage through pressure vessel 100 from an outside environment to the interior space 108. As described later, boss assembly 110 is generally installed during manufacture so as to be integral with pressure vessel 100. It is to be appreciated, however, that boss assembly can be coupled to vessel 100 after manufacture or incorporated with other techniques before or after manufacture.

Boss 200 is configured to at least partially accept an insert 206 at a center aperture through boss 200, which is in fluid communication with interior space 108. Insert 206 secures to boss 200 via threading or other securing means (e.g. bolts, pins, adhesives, etc.). Insert 206 can include a central passage, which also provides fluid communication with interior space 108. According to an aspect, insert 206 can include other features to enable coupling to a valve or fluid distribution system to enable flow of a fluid contained within interior space 108.

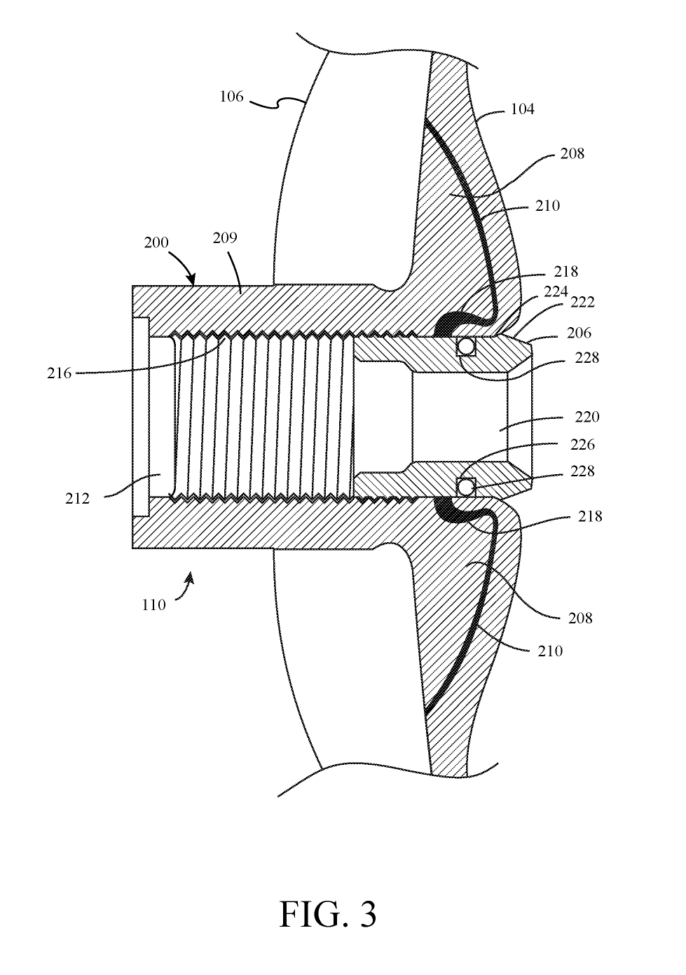

Turning to FIG. 3, illustrated is an exemplary cross-sectional view of pressure vessel 100 showing an interface between boss 200 and liner 104 according to an aspect. As depicted, boss assembly 110 includes boss 200 and insert 206 as described above. Boss 200 is located within coaxially-aligned openings 202, 204 in the liner 104 and shell 106, respectively. As depicted, boss 200 includes a neck portion 209 and a flange 208 located at and encircling an inner end of the neck portion 209. Here, “inner” refers to a relative position proximate to interior space 108 when boss 200 is installed on tank 102 and “outer” refers to an opposite position and, therefore, near an exterior environment of tank 102 when boss 200 is installed.

Flange 208 extends radially outward from boss 200 and between liner 104 and shell 106. Flange 208 has a generally planar outer surface that engages with shell 106 and a convex inner surface that engages with a plastic layer 210. A thickness of flange 208, measured in a direction along longitudinal axis 118 of pressure vessel 100, decreases radially outward. Thus, flange 208 is thinner at a terminal end than at a more central portion where flange 208 attaches to neck portion 209. In an aspect, boss 200 is aluminum, but substantially any other metal can be employed.

Plastic layer 210 forms a seal at an interface between flange 208 and liner 104. Plastic layer 210 adheres to both flange 208 and liner 104 to secure the two members together and seal the interface. Plastic layer 210 prevents fluid to flow from interior space 108, through opening 202 of liner 104, and along the interface between boss 200 and liner 104. Additionally, plastic layer 210 increases a torque strength of boss 200. For instance, when insert 206 is threaded into boss 200, the resultant torque can cause slippage at the interface between boss 200 and liner 104. Plastic layer 210, by increasing torque strength, reduces such slippage.

According to an example, plastic layer 210 and liner 104 include different plastic or polymeric materials. Thus, the material of plastic layer 210 provides sufficient adhesion to both boss 200 and liner 104 to form a high-pressure seal at the interface. In one exemplary, non-limiting embodiment, plastic layer 210 includes a modified thermoplastic polyethylene such as, for example, MICROTHENE MR SP010, available from Equistar Chemicals, LP of Houston, Tex., which is a modified thermoplastic polyethylene-based rotolining and powder coating resin that provides excellent adhesion to metal and other polymers. It is to be appreciated, however, that other materials, providing suitable adhesion to both boss 200 and liner 104, can be selected to form layer 210.

Boss 200 includes a central passage or port 212 extending entirely through boss 200 from an exterior portion to an interior portion in communication with interior space 108. That is, the passage 212 extends through both neck portion 209 and flange 208. The central passage 212 carries threading 216 on a surface forming the passage. Threading 216 cooperates with corresponding threading on components (e.g. valves, vents, caps, etc.) for securing such components to boss 200. At an innermost portion, the central passage 212 includes an engagement surface 218. Surface 218 is located, for example, opposite a terminal end of flange 208 and, thus, can be considered a radially-inward surface of flange 208 within passage 212. Similar to the convex surface of flange 208, engagement surface 218 also carries plastic layer 210. As shown in FIG. 3, engagement surface 218 includes a groove, however, such an indentation is optional according to one or more embodiments. As described later, engagement surface 218 receives a lip portion of liner 104, which forms opening 202.

Insert 206 is secured within passage 212 of boss 200. Insert 206 includes a port 220 that connects passage 214 of boss 200 with interior space 108 formed by liner 104. Port 220 is coaxial with passage 212 and, accordingly, insert 206 is also coaxially aligned with passage 212. Like boss 200, insert 206 can be aluminum, other suitable metal, or formed from a non-metal material.

Insert 206 has a cylindrically-shaped body 222 and port 220 extends from an outer portion to an inner portion of body 222 to allow fluid communication from interior space 108 through insert 206. An outer portion of insert 206 includes threads which engage threading 216 of boss 200 to facilitate insertion and securing of insert 206 to boss 200. An inner portion of insert 206 includes a tapered exterior surface 224 having a decreasing outer diameter in an inward direction. When inserted, tapered surface 224 engages liner 104, the lip of which is positioned between insert 206 and boss 200 along engagement surface 218. The tapered surface 224 operates to compress liner 104 against engagement surface 218.

A groove 226 is provided on tapered surface 224 and configured to receive a seal member 228. Seal member 228 forms another seal between boss 200 and liner 104 to prevent a leaking flow of fluid along the boss-liner interface. In particular, the compression of liner 104 against engagement surface 218, by tapered surface 224, facilitates tight engagement of seal member 228 with liner 104 opposite of engagement surface 218. Seal member 228 can be an O-ring located in groove 226. It is to be appreciated that other configurations are contemplated. For instance, seal member 228 can be a O-ring or other material encircling tapered surface 224 and adhered thereto instead of disposed within groove 226. When coupled with seal member 228, plastic layer 210 operates as a secondary seal particular when fluid escapes around the seal formed by seal member 228.

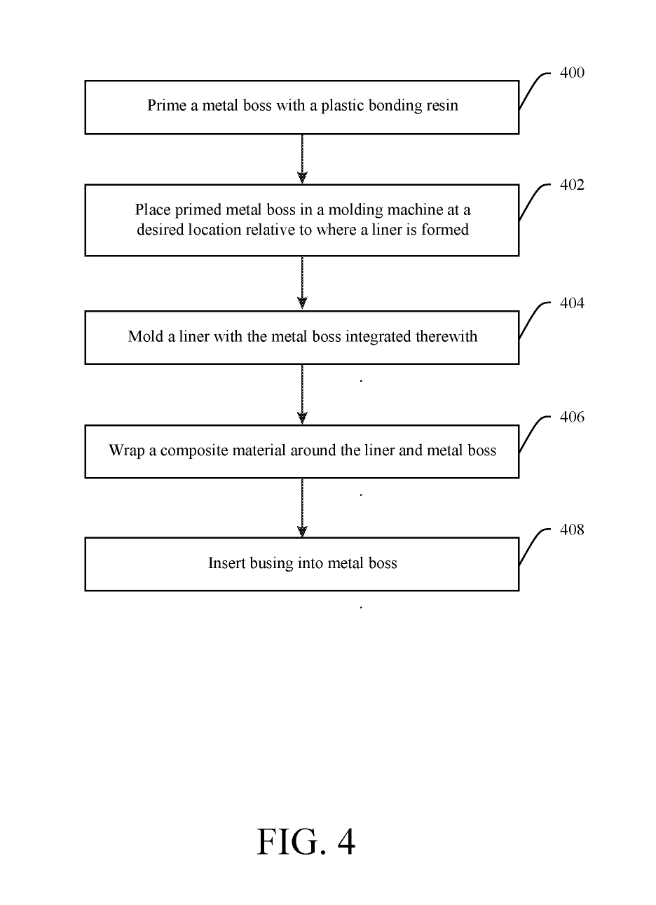

FIG. 4 illustrates a flow diagram of an exemplary, non-limiting method for making or manufacturing a pressure vessel in accordance with one or more aspects described herein. For example, the method of FIG. 4 can be employed to manufacture pressure vessel 100 described above. At 400, a boss (such as boss 200) is primed with plastic bonding resin. In particular, the resin is applied to any surface of the boss on which plastic layer 210, for example, adheres. To apply the resin which becomes plastic layer 210, the boss first undergoes a baking process. For example, the boss can be baked at 400 degree Fahrenheit for about one hour. After baking, and while still hot, the boss is dipped into a container holding the plastic bonding resin to coat the desired surface. For instance, the boss is dipped in the resin for about ten seconds before removal. To prevent contamination of any internal threading of the boss, a plug can be inserted into a central passage of the boss. For example, a thread Teflon plug can be inserted into boss to prevent plastic layer 210 from forming on the threading of the central passage of the boss. After removal, the primed boss is removed and allowed to cool with the primed surface facing up. Once cooled, any flash or extraneous material can be trimmed.

At 402, the primed boss is placed in a molding machine at a desired location relative to where the molding machine will form a liner (such as liner 104). The molding machine can be a rotational lining or molding machine, according to one example. At 404, the liner is formed. In particular, a plastic resin powder, different from the material used to prime the boss, is added to the mold. An oven is programmed to rotationally mold the liner with the boss integral therewith and carrying the plastic layer at the interface. For instance, the oven can be programmed bake the mold at 560 degrees Fahrenheit for 26 minutes. The molded liner is cooled and removed from the molding machine. An opening in the liner through the boss can be bored or otherwise formed.

At 406, a composite shell is formed around the liner. Specifically, the composite shell is wound around, using a pressure winding process, or otherwise formed on an outer surface of the liner except where the boss is integrated. The composite shell can be a fiber-reinforced polymer overwrap such as, for example, carbon fibers bonded together by a thermosetting or thermoplastic resin. The composite shell is subjected to a gelling step where the composite shell is heated under pressure to homogenize the resin and release air entrapped in the resin during winding. The composite shell is subsequently cured under pressure.

At 408, a bushing or other object can be inserted into the boss. For instance, the bushing is inserted from outside the pressure vessel and tightened to a desired torque. The bushing, when inserted, compresses the liner into the boss to engage a primary seal. The plastic layer, described above, forms a secondary seal. Optional dome caps can be secured to the pressure vessel via an adhesive to finish the pressure vessel.

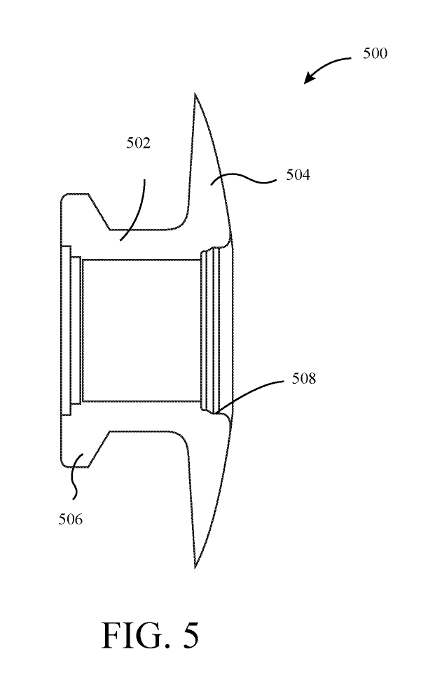

FIG. 5 illustrates an alternative boss 500 having a configuration in accordance with another embodiment. Like boss 200 described above, boss 500 includes a neck portion 502 and flange 504 similarly arranged. Boss 500 further includes an outer flange 506 disposed at an outer end of neck portion 502. Flange 506 facilitates engagement and securing of a composite shell with boss 500. Boss 500 additionally includes an engagement surface 508 having a different configuration from surface 218 of boss 200. As shown in FIG. 5, engagement surface 508 lacks a groove, which enhances manufacturability.

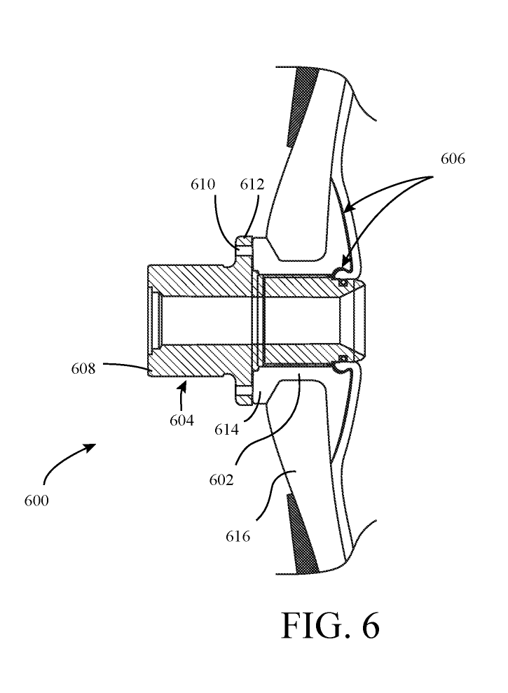

FIG. 6 depicts another configuration of a boss assembly suitable for a pressure vessel. Boss assembly 600 includes a boss 602 and an insert 604 and, while a variation of boss assembly 110, incorporates the sealing technique described above as shown by plastic layer 606. Insert 604 provides an outer mounting portion of adapter 608. This configuration permits a plurality of different adapters to be utilized in connection with a common boss 602. For instance, various inserts 604 having different adapters 608 can be swapped depending on a desired application for the pressure vessel. In addition to engagement via threading, insert 604 can be further secured to boss 602 via pins 610, which pass through a radially-extending flange 612 of insert 604 that engages an outer surface 614 of boss 602. According to an example, pins 610 can be press-fit lock pins. As additionally shown in FIG. 6, outer surface 614 is formed by a flange or rib portion that facilitates locking a composite shell 616 to boss assembly 600 and transferring load thereto.

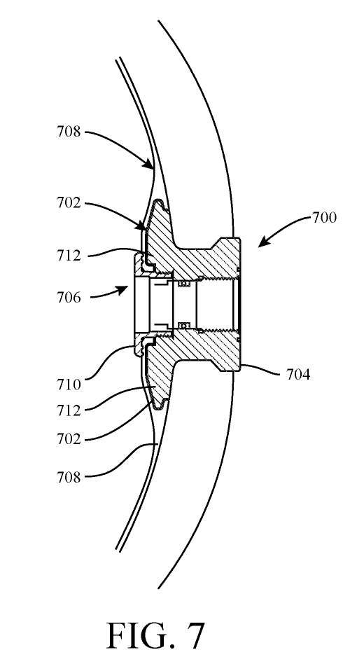

FIG. 7 illustrates yet another boss assembly configuration. Boss assembly 700 can incorporate sealing techniques utilizing plastic layer 702 for pressure vessels having liners formed by methods other than rotational molding. Boss 704 and insert 706 are configured so that insert 706 is secured to boss 704 from inside of the pressure vessel. To provide access to an inner side of boss 704, a liner 708 of the pressure vessel can be molded in at least two portions (e.g. two halves) by, for example, injection molding or the like. With access to an inner side of boss 704, liner 708 can be captured or pinched between the boss 704 and insert 706. When threaded into boss 704, a flange 710 of insert 706 engage and clamps liner 708 against an inner surface of flange 712 of boss 704.

Additional configurations for boss assemblies that can incorporated the interface layer disclosed herein are described in U.S. patent application Ser. No. 15/450,493, entitled BOSS ASSEMBLY FOR COMPOSITE CYLINDER. The entirety of this application is herein incorporated by reference.

Pressure vessels and methods of making pressure vessels have been disclosed herein. In particular, a pressure vessel is described having a plastic liner forming a hollow interior space, a composite wrap covering the plastic liner, and a boss assembly including a metal boss. The metal boss is located at openings though the plastic liner and the composite wrap and has a flange extending radially outward between the plastic liner and the composite wrap. A plastic layer is located between and adhered to the plastic liner and the flange of the metal boss sealingly to secure the plastic liner to the flange of the metal boss and to form a seal for the interface between the metal boss and the plastic liner.

An alternative pressure vessel includes a plastic liner of HDPE that forms a hollow interior space, a carbon-fiber composite wrap covering the plastic liner, and a boss assembly including an aluminum boss and an insert. The metal boss is located at openings though the plastic liner and the composite wrap and has a flange extending radially outward between the plastic liner and the composite wrap. The aluminum boss has a central passage with an internal thread. The insert is located at least partially within the central passage of the aluminum boss and has an external thread cooperating with the internal thread of the aluminum boss to secure the insert to the aluminum boss. The plastic liner partially extends between the insert and the aluminum boss. The insert has a central passage connecting the central passage of the aluminum boss with the hollow interior space of the plastic liner. A molded plastic layer formed with a modified thermoplastic polyethylene-based resin is located between and adhered to the plastic liner and the flange of the aluminum boss to sealingly secure the plastic liner to the flange of the aluminum boss and to form a seal for the interface between the aluminum boss and the plastic liner.

To manufacture such a pressure vessel described herein, a boss assembly is obtained that includes a metal boss having a radially-outward extending flange. Next, a plastic liner is molded to form a hollow interior space. The metal boss is secured to the plastic liner by molding a plastic layer between the plastic liner and the flange of the metal boss to sealingly secure the plastic liner to the flange of the metal boss and to form a seal for an interface between the metal boss and the plastic liner, and forming a composite wrap covering the plastic liner and the flange of the metal boss.

It is to be appreciated that various features or aspects of the embodiments described herein can be utilized in any combination with any of the other embodiments.

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean “serving as an illustration or example of something.”

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pressure vessel, comprising:
a liner forming a hollow interior space;
a composite shell covering the liner;
a metal boss positioned within respective openings through the liner and the composite shell, the metal boss having a flange extending between the liner and the composite shell; and
a plastic layer disposed between the liner and the metal boss to form a seal at the interface between the metal boss and the liner.

2. The pressure vessel of claim 1, further comprising an O-ring configured to form a second seal between the liner and metal boss.

3. The pressure vessel of claim 1, wherein the metal boss includes a central passage configured to receive and secure an insert at least partially within the central passage, the insert includes a central port providing a channel between the central passage of the metal boss and the hollow interior space formed by the liner.

4. The pressure vessel of claim 3, wherein the insert carries an O-ring to form a second seal where a lip of the liner extends between the insert and the metal boss.

5. The pressure vessel of claim 3, wherein, upon insertion, the insert compresses a lip of the liner against the metal boss to form a second seal.

6. The pressure vessel of claim 1, wherein the metal boss comprises aluminum.

7. The pressure vessel of claim 1, wherein the liner comprises high-density polyethylene.

8. The pressure vessel of claim 1, wherein the plastic layer comprises a material providing adhesion to both the metal boss and a material of the liner.

9. The pressure vessel of claim 1, wherein the plastic layer comprises a modified thermoplastic polyethylene-based resin.

10. The pressure vessel of claim 1, wherein the flange of the metal boss includes a convex inner surface on which the plastic layer adheres to secure the liner to the metal boss and form the seal at the interface.

11. A pressure vessel comprising:
a liner forming a hollow interior space configured to contain a fluid;
a carbon-fiber composite wrap covering the liner to form a shell;
a boss assembly positioned within respective openings through the liner and the composite wrap, the boss assembly includes:
a metal boss having a central passage and a flange extending radially outward from a main portion of the metal boss and between the liner and the composite wrap, and
an insert configured to be at least partially received within the central passage; and
a plastic layer formed between the flange of the metal boss and the liner to secure the metal boss to the liner and to form a seal along an interface between the metal boss and the liner.

12. The pressure vessel of claim 11, wherein the central passage of the metal boss includes internal threads and the insert includes external threads such that the external threads of the insert cooperate with the internal threads of the metal boss to secure the insert when the insert is torqued during insertion.

13. The pressure vessel of claim 11, further comprising an O-ring externally positioned on the insert to form a second seal between the liner and the metal boss when the insert is at least partially received within the central passage of the metal boss.

14. The pressure vessel of claim 11, wherein the liner includes a lip that at least partially extends into the central passage of the metal boss.

15. The pressure vessel of claim 14, wherein the insert includes a tapered inner portion configured to compress the lip of the liner against an engagement surface of the metal boss during insertion.

16. The pressure vessel of claim 15, wherein the engagement surface includes a partially recessed groove to receive the liner compressed by the insert.

17. The pressure vessel of claim 15, the plastic layer is disposed on and between the engagement surface of the metal boss and the liner.

18. A method of manufacturing a pressure vessel, comprising:
priming at least one surface of a metal boss with a plastic layer;
molding a liner forming a hollow interior space with the metal boss integrated therewith, the metal boss including a flange extending radially-outward which is at least partially integrated with the liner during molding; and
forming a composite wrap that covers the liner and at least the flange of the metal boss.

19. The method of claim 18, wherein the liner is rotationally molded and the plastic layer is formed on an inner surface of the flange so as to be between the metal boss and the liner when molded.

20. The method of claim 18, further comprising:
injection molding the liner as at least two separate portions;
coupling an insert to the metal boss from an inner side of the metal boss; and
joining the at least two separate portions of the liner together after coupling.
